(19) United States
(12) Patent Application Publication
(10) Pub. No.: US 2007/0016519 A1
(43) Pub. Date: Jan. 18, 2007

(54) SYSTEMS AND METHODS FOR INVENTORY FINANCING

(75) Inventors: Calvin E. Blount JR., Atlanta, GA (US); Mark E. Conard, Roswell, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 11/457,328

(22) Filed: Jul. 13, 2006

Related U.S. Application Data
(60) Provisional application No. 60/699,715, filed on Jul. 15, 2005.

(51) Int. Cl. G06Q 40/00; G06Q 10/00

(52) U.S. Cl. 705/38; 705/28

(57) ABSTRACT

Various embodiments of the present invention provide a system that enables lenders to provide more favorable financing arrangements to borrowers that are willing to use their warehoused inventory as collateral for the financing arrangement. In particular, the system provides a mechanism through which the lender can receive more information about and exercise a higher level of control over the warehoused inventory that secures a financing arrangement, which provides the lender with the security that the collateral will be accessible in the event of the borrower's default. for example, such information may include what is in the inventory, where the inventory is located, the quantities of each asset within the inventory, the value of each asset in the inventory, and whether the lender can access and liquidate the assets in the event the borrower defaults on the financing arrangement.

### CROSS REFERENCE TO RELATED APPLICATIONS

This application claims priority from provisional U.S. Application No. 60/699,715 entitled “Systems and Methods for Inventory Financing,” which was filed on Jul. 15, 2005 and which is hereby incorporated by reference in its entirety.

### FIELD OF INVENTION

This invention relates generally to systems and methods for providing secured financing, and, more particularly to providing financing secured by inventory.

### BACKGROUND OF THE INVENTION

Inventory financing includes financing arrangements in which inventory serves as collateral for the financing. Typically, inventory financing is available when inventories are highly marketable and the threat of obsolescence does not exist. When determining the cost of financing the inventory to the borrower, lenders or their agents take into consideration the risks of collecting on the loan, the probability of being able to create, perfect, and enforce the lien on the inventory, and the likelihood that the inventory will be available in the case of default or bankruptcy by the borrower. These risks are especially present for a U.S. lender when the inventory securing the loan is stored in a warehouse located outside of the United States due to the differences among jurisdictions in how security interests are created and perfected.

Lenders or their agents offer various types of financing arrangements to borrowers willing to use their inventory as collateral for the financing arrangement. The types of liens available for attaching to the collateral depend on the jurisdiction in which the goods are warehoused. For example, some jurisdictions recognize floating liens, which are security interests in the entire inventory stock and attach to the items present within a warehouse. With floating liens, the lender bears the risk that there will be no assets in the warehouse if the borrower defaults or becomes bankrupt and the lender attempts to collect on the collateral. In light of this risk, lenders provide less favorable financing terms for floating liens, such as providing an advance rate of 30% to 40% at an interest rate of 6% over the prime lending rate. Advance rate refers to the percentage of the value of the assets that the lender is willing to advance to the borrower subject to the financing agreement. For example, if the advance rate is 60% and the assets have a total value of $100,000, the lender will advance up to $60,000 to the borrower.

Another type of lien recognized by some jurisdictions is a fixed charge lien, which affixes to specific pieces of equipment, thus making the collateral available and accessible to the lender in the event of default or bankruptcy by the borrower. To perfect a fixed charge lien, the lender typically has to show that the lender can identify each piece of equipment and control the physical possession of the equipment. This level of control over the equipment gives lenders more security that the equipment will be available for collection in the event of default of the borrower, and fixed charge liens, where available, typically have a higher priority than floating liens. Because of the level of security obtained with a fixed charge lien, lenders are more likely to offer more favorable financing for equipment secured by a fixed charge lien.

However, currently, U.S. lenders and their agents generally do not offer favorable financing on inventory stored in warehouses outside of the United States because current warehousing management systems have not been developed with the functionality to provide the information and control abilities desired by lenders. For example, the inability of the lender to receive up-to-date item (SKU) or carton level information about the assets and demonstrate a high level of control over the assets prevents the lender from securing favorable liens, such as fixed charge liens, against warehoused inventory. Furthermore, some jurisdictions require a daily inventory report be submitted to local lien authorities to ensure that the inventory is being controlled by the lender and that shrinkage of the inventory is minimal or non-existent.

Current warehousing management systems have not been developed with the functionality to provide up-to-date information, manage assets with a high level of control, and generate daily inventory reports for a local lien authority. Providing this functionality proves especially difficult when the assets move rapidly through a warehouse, such as assets having a residence time of one day to one month.

Another alternative method of financing inventory involves the lender taking ownership of the inventory until the borrower satisfies the financing agreement. For example, the lender may take ownership of the inventory when the inventory enters the warehouse, and the lender will transfer ownership back to the borrower upon satisfaction of the financing agreement. However, taking ownership of the inventory presents several disadvantages to the lender, such as the requirement to book non-performing assets on the balance sheet, which may affect the owner's credit rating, tax liabilities associated with owning the inventory, and assuming the risk that the inventory will be lost, damaged, or stolen.

Therefore, a need in the art exists for a system that enables lenders to provide more favorable financing to borrowers by taking security interests in borrower-owned inventory that is temporarily stored in warehouses or is in transit to a final destination.

### BRIEF SUMMARY OF THE INVENTION

Various embodiments of the present invention provide a system that enables lenders to provide more favorable financing arrangements to borrowers that are willing to use their warehoused inventory as collateral for the financing arrangement. In particular, the system provides a mechanism through which the lender can receive more information about and exercise a higher level of control over the warehoused inventory that secures a financing arrangement, which provides the lender with the security that the collateral will be accessible in the event of the borrower's default. For example, such information may include what is in the inventory, where the inventory is located, the quantities of each asset within the inventory, the value of each asset in the inventory, and whether the lender can access and liquidate the assets in the event the borrower defaults on the financing arrangement.

According to various embodiments of the invention, a warehousing entity utilizes a computer system to track collateral information and manage the collateral within a warehouse managed by the warehousing entity. In one embodiment, the computer system includes a warehouse management system, which is employed to assist the warehousing entity in identifying each asset received into the warehouse on an item or carton-level basis and tracking each asset as it moves through the warehouse, and an inventory finance management system, which is employed to manage the financing aspects of the warehousing arrangement and how the assets are controlled while stored within the warehouse. The warehouse management system, according to one embodiment, includes an inventory data collection module that receives and updates inventory data, a warehousing operation module that executes release requests from the borrower, and an inventory reporting module that generates a report of the inventory currently held within the warehouse and a report of the inventory received into the warehouse from a particular borrower. Furthermore, the warehouse management system includes a quantity validation module that compares the quantity received by or on-hand at the warehouse to the quantity expected and assists the warehousing entity in handling variations in the quantity of assets received or present in the warehouse from the quantity of assets expected.

The inventory finance management system, according to one embodiment, includes an asset cost association module for receiving the cost price per unit for each asset stored in the warehouse, associating the cost price with the asset information stored in the warehouse management system, and updating the cost price in the warehouse management system if changes in the cost price occur. In addition, the inventory finance management system includes a release request processing module that compares a release request from a borrower to criteria for release requests set forth by the lender and determines whether the release request can be approved or forwards the release request to the lender for the lender to evaluate directly. The inventory finance management system also includes an inventory financing reporting module that utilizes the asset information stored by the warehouse management system to generate inventory reports that indicate the inventory available in the warehouse at a predetermined cut-off time, such as at the close of business daily. These reports may be transmitted to or filed with the local lien authority and may be transmitted or otherwise made available to the borrower and the lender.

According to various embodiments, a computer system is provided for facilitating the exercise of control over an asset stored within a warehouse. The asset is owned by a borrower and designated as collateral for a loan provided to the borrower by a lender. The system includes an asset manager, a release manager, and a report generator. The asset manager is adapted for (a) storing an asset identifier for the asset located within the warehouse and (2) associating and storing a lender identifier associated with the asset. The asset identifier identifies the asset and the lender identifier identifies the lender as having a lien against the asset. The release manager is adapted for (1) storing release criteria associated with the lender and, (2) in response to receiving a release request from the borrower to release the asset associated with the lender, comparing the release request to the release criteria associated with the lender. The report generator is adapted for generating a report of the asset within the warehouse at a given time and transmitting the report to a lien authority.

According to other embodiments of the invention, an inventory management system is provided for managing one or more warehoused assets that secure a loan. The system includes a memory adapted for storing release criteria associated with a lender and an inventory report provided by a warehousing entity that is storing the warehoused assets. The inventory report includes asset information for each of the warehoused assets. The system further includes a processor that is adapted for executing the steps of (1) receiving a release request from a borrower that identifies at least one of the warehoused assets owned by the borrower; (2) in response to receiving the release request, comparing the release request to the release criteria; and (3) in response to determining that the release request meets the release criteria, approving the release request and generating instructions for the warehoused assets to be released from the warehouse.

According to various embodiments of the invention, a method for facilitating the perfection of a lien against one or more assets within a warehouse is provided. In one embodiment, the method includes the steps of: (1) receiving the assets subject to the lien into the warehouse; (2) storing an asset identifer for each of the assets in a memory, wherein the asset identifier identifies the asset; (3) associating in the memory a lender identifier with each asset identifier, wherein the lender identifier identifies the lender holding the lien; (4) associating in the memory a location identifier with each asset identifier, wherein the location identifier identifies a physical location of the asset within said warehouse; and (5) generating an inventory report that includes the asset identifier, the lender identifier, and the location identifier for each asset within the warehouse at a given time.

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram showing a flow of information in a system according to one embodiment of the invention in which a separate entity provides an interface between a lender and a warehousing entity.

FIG. 2 is a schematic diagram illustrating a system according to one embodiment of the invention.

FIG. 3 is a schematic diagram illustrating a warehouse management system according to one embodiment of the invention.

FIG. 4 is a schematic diagram illustrating an inventory finance management system according to one embodiment of the invention.

FIG. 5 is a flowchart illustrating an overview of the operation of the system according to one embodiment of the invention.

FIG. 6 is a flow diagram of a method of processing a request to advance funds under a financing agreement according to one embodiment of the invention.

FIG. 7 is a flow diagram of a method of processing a request to release assets according to one embodiment of the invention.

FIG. 8A is a diagram of the agreement and agreement terms between the borrower and the lender according to one embodiment of the invention.

FIG. 8B is a diagram of the agreement and agreement terms between the warehousing entity and the lender according to one embodiment of the invention.

FIG. 9 is a diagram of the agreement and agreement terms between the warehousing entity and the borrower according to one embodiment of the invention.

FIG. 10 is a schematic diagram of a warehouse environment according to one embodiment of the invention.

FIG. 11 is a flow diagram of a method of receiving and verifying inventory according to one embodiment of the invention.

FIG. 12 is a flow diagram of a method of monitoring inventory and inventory levels according to one embodiment of the invention.

FIG. 13 is a flow diagram illustrating the operation of a release request processing module according to one embodiment of the invention.

FIG. 14 is a flow diagram illustrating the operation of a warehousing operation module according to one embodiment of the invention.

FIG. 15 is a flow diagram of a method of picking, packing, and shipping goods according to one embodiment of the invention.

FIG. 16 is a flow diagram illustrating the operation of an inventory financing reporting module according to one embodiment of the invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

As will be appreciated by one skilled in the art, the present invention may be embodied as a method, a data processing system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, or magnetic storage devices.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks the computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Brief Overview

Various embodiments of the present invention provide a system that enables lenders to provide more favorable financing arrangements to borrowers that are willing to use their warehoused inventory as collateral for the financing arrangement. In particular, the system provides a mechanism through which the lender can receive more information about and exercise a higher level of control over the warehoused inventory that secures a financing arrangement, which provides the lender with the security that the collateral will be accessible in the event of the borrower's default. For example, such information may include what is in the inventory, where the inventory is located, the quantities of each asset within the inventory, the value of each asset in the inventory, and whether the lender can access and liquidate the assets in the event the borrower defaults on the financing arrangement.

In addition to providing the lender with a greater sense of security in the financing arrangement, having this level of information and control over the inventory enables the lender to create and perfect a higher priority lien in the inventory in some jurisdictions. For example, as mentioned above, if the assets subject to the security interest are identifiable on an item or carton-level basis and the lender is able to demonstrate physical control over the assets, such as by preventing the release of the assets without the lender's permission, the lender may be able to create and perfect a fixed charge lien against the assets. One of skill in the art will understand that various embodiments of the system may enable the lender to create and perfect other types of higher priority liens in inventory, depending on the types of liens recognized by the jurisdiction, and the nomenclature of the liens may vary depending on the jurisdiction. Thus, although fixed charge liens are an example of a favorable lien, other types of favorable liens may be created depending on the types of liens recognized in the particular jurisdiction.

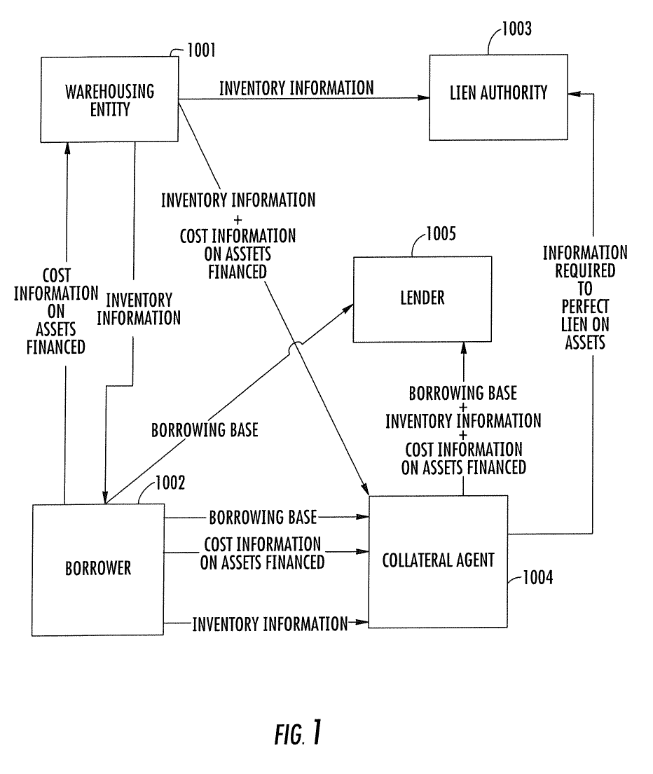

The present invention contemplates a relationship between the borrower, the warehousing entity, and the lender. The term “lender” as used herein can include a syndicate of lenders providing a financing facility, which is a group of lenders that have each agreed to provide a portion of the money for the financing facility and share the risk associated with the financing facility, or an agent for a lender or a syndicate of lenders. For example, as shown in FIG. 1, in an exemplary operation of the system, the warehousing entity 1001 provides inventory information to the borrower 1002, including information about the assets owned by the borrower 1002 within the warehouse. The borrower 1002 uses the inventory information to prepare a borrowing base, which is information on the assets in the warehouse that serve as collateral for the financing arrangement and accounts receivable for sales of assets. The borrowing base is then provided to a collateral agent 1004 acting on behalf of a lender 1005 or directly to the lender 1005.

In addition, the warehousing entity 1001 provides inventory information to the collateral agent 1004 and to the local lien authority 1003. Providing the inventory information to the local lien authority 1003 may be required in some jurisdictions to perfect the lien attached to the inventory in the warehouse. The borrower 1002 provides cost information, such as a cost price per asset and currency exchange values on assets financed, to the collateral agent 1004 and the warehousing entity 1001, and the warehousing entity 1001 provides the cost information received from the borrower 1002 to the collateral agent 1004. The borrower 1002 may also provide inventory information to the collateral agent 1004. The collateral agent 1004 evaluates the inventory information and cost information provided by the warehousing entity 1001 and the borrowing base, inventory information, and cost information provided by the borrower 1002 for any discrepancies. In addition, the collateral agent 1004 associates the cost information with the borrowing base and the inventory information and presents the associated information to the lender 1005. A portion of the associated information may also be presented to the borrower 1002, depending on the agreement between the borrower 1002 and the lender 1005. In addition, information for perfecting the lien on the assets, such as inventory information, may be presented by the collateral agent 1004 to the lien authority 1003, depending on the lien perfection requirements of the jurisdiction. In one embodiment, in addition to the inventory information, the local lien authority 1003 may require that the associated cost information or the associated borrowing base information be presented.

The lender 1005 evaluates the borrowing base, the inventory information, and the cost information to determine whether to advance funds or release assets to the borrower 1002, for example. Although FIG. 1 illustrates information flowing through a collateral agent 1004, which is independent of a lender 1005 or lending syndicate, the information can flow directly to the lender 1005 or a member of the lending syndicate in another embodiment (not shown).

In one embodiment, the warehousing entity 1001 utilizes a computer system to track collateral information and manage the collateral. The computer system includes a warehouse management system, which is employed to assist the warehousing entity in identifying each asset received into the warehouse on an item or carton-level basis and tracking each asset as it moves through the warehouse, and an inventory finance management system, which is employed to manage the financing aspects of the warehousing arrangement and how the assets are controlled while stored within the warehouse. The warehouse management system includes an inventory data collection module that receives and updates inventory data, a warehousing operation module that executes release requests from the borrower, and an inventory reporting module that generates a report of the inventory currently held within the warehouse and a report of the inventory received into the warehouse from a particular borrower. Furthermore, the warehouse management system includes a quantity validation module that compares the quantity received by or on-hand at the warehouse to the quantity expected and assists the warehousing entity in handling variations in the quantity of assets received or present in the warehouse from the quantity of assets expected.

The inventory finance management system includes an asset cost association module for receiving the cost price per unit for each asset stored in the warehouse, associating the cost price with the asset information stored in the warehouse management system, and updating the cost price in the warehouse management system if changes in the cost price occur. In addition, the inventory finance management system includes a release request processing module that compares a release request from a borrower to criteria for release requests set forth by the lender and determines whether the release request can be approved or forwards the release request to the lender for the lender to evaluate directly. The inventory finance management system also includes an inventory financing reporting module that utilizes the asset information stored by the warehouse management system to generate inventory reports that indicate the inventory available in the warehouse at a predetermined cut-off time, such as at the close of business daily. These reports may be transmitted to or filed with the local lien authority and may be transmitted or otherwise made available to the borrower and the lender.

System Architecture

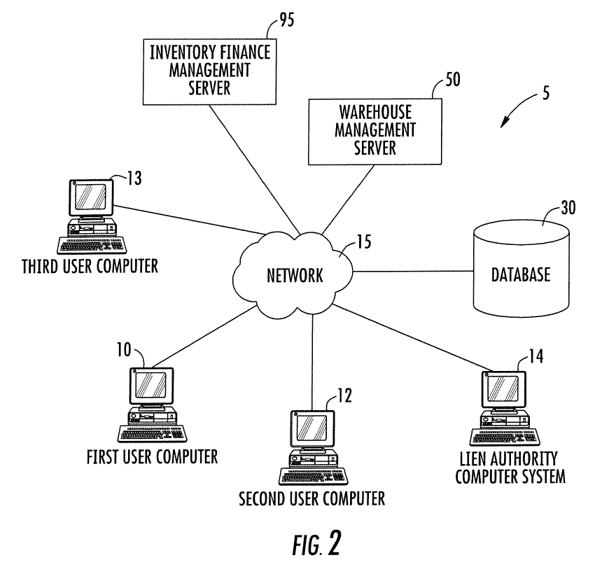

A system 5 according to one embodiment of the invention is shown in FIG. 2. As may be understood from this figure, in this embodiment, the system includes one or more user computers 10, 12, 13 and a lien authority computer 14 that are connected, via a network 15 (e.g., a LAN or the Internet), to communicate with a warehouse management system 50 and an inventory finance management system 95. In one embodiment of the invention, the warehouse management system 50 and the inventory finance management system 95 are configured for retrieving data from, and storing data to, a database 30 that may be stored on (or, alternatively, stored remotely from) the warehouse management system 50 or the inventory finance management system 95. In an alternative embodiment, the system 5 may include more than one database 30. In other embodiments, the warehouse management system 50 and the inventory finance management system 95 may be one or more computers or software programs running on one or more computers.

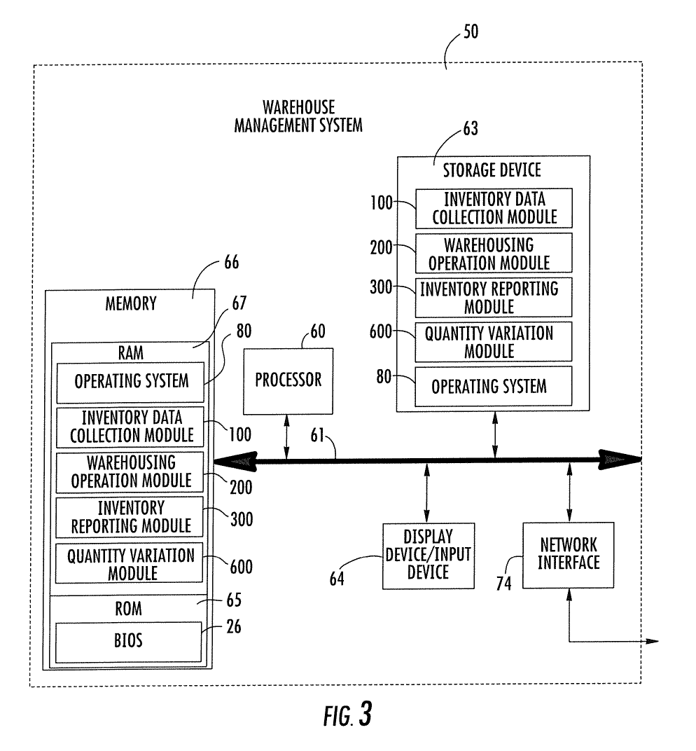

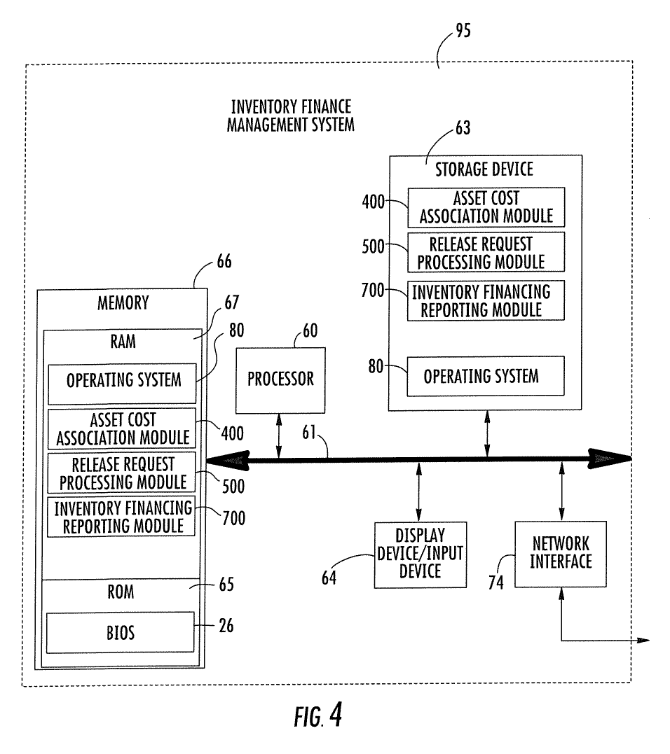

FIGS. 3 and 4 show schematic diagrams of a warehouse management system 50 and an inventory finance management system 95, respectively, according to one embodiment of the invention. The warehouse management system 50 and inventory finance management system 95 each include a processor 60 that communicates with other elements within the computer systems 50, 95 via a system interface or bus 61. Also included in the systems 50, 95 is a display device/input device 64 for receiving and displaying data. This display device/input device 64 may be, for example, a keyboard or pointing device that is used in combination with a monitor. The systems 50, 95 further includes memory 66, which preferably includes both read only memory (ROM) 65 and random access memory (RAM) 67. The systems ROM 65 is used to store a basic input/output system 26 (BIOS), containing the basic routines that help to transfer information between elements within the systems 50, 95. Alternatively, the warehouse management system 50 and the inventory finance management system 95 can operate on one computer or on multiple computers that are networked together.

In addition, the systems 50, 95 include at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. For example, as shown in FIG. 3, program modules of the warehouse management system 50 include an operating system 80, an inventory data collection module 100, a warehousing operation module 200, an inventory reporting module 300, and a quantity variation module 600. The inventory data collection module 100, the warehouse operation module 200, the inventory reporting module 300, and the quantity variation module 600 control certain aspects of the operation of the warehouse management system 50, as is described in more detail below, with the assistance of the processor 60 and an operating system 80. According to one embodiment, the inventory data collection module 100 and the warehousing operation module 200 are included in warehouse management software, such as Exceed™, published by EXE. And, in another embodiment, the reporting module 300 is included in visibility software, such as Flex Global View (FGV), which is described in U.S. Published Patent Application No. 2005/0149373.

As another example, as shown in FIG. 4, program modules of the inventory finance management system 95 include an operating system 80, an asset cost association module 400, a release request processing module 500, and an inventory financing reporting module 700. The asset cost association module 400, the release request processing module 500, and the inventory financing reporting module 700 control certain aspects of the operation of the inventory finance management system 95, as is described in more detail below, with the assistance of the processor 60 and an operating system 80.

Also located within the systems 50, 95 is a network interface 74, for interfacing and communicating with other elements of a computer network. It will be appreciated by one of ordinary skill in the art that one or more of the systems 50, 95 components may be located geographically remotely from other system 50, 95 components. Furthermore, one or more of the components may be combined, and additional components performing functions described herein may be included in the systems 50, 95.

Exemplary System Operation

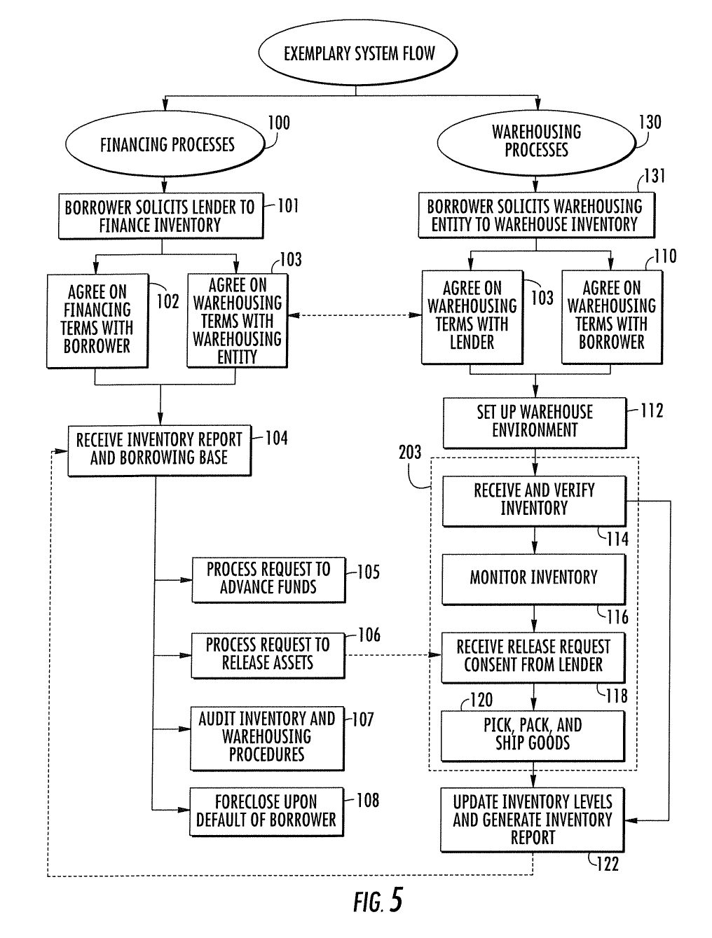

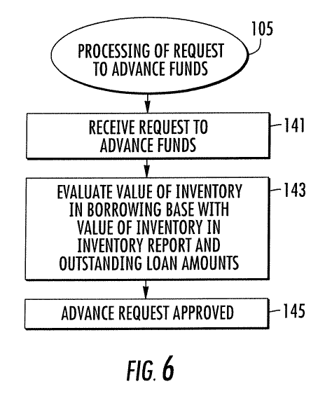

FIG. 5 illustrates a flowchart of an exemplary operation of the system according to one embodiment of the invention, and each of the steps is described in more detail below in reference to FIGS. 6 through 16. As mentioned above, the system enables lenders to provide more favorable financing arrangements to borrowers on warehoused inventory by providing the lenders and warehousing entities with the ability to identify the assets on an item or carton-level basis and exercise more control over the possession of the assets, such as controlling the release of the assets. Thus, the exemplary system operation is described below by reference to financing 100 and warehousing 130 processes that occur within this embodiment of the system.

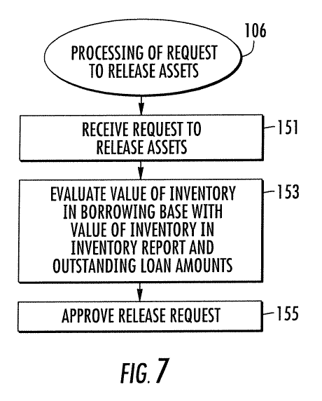

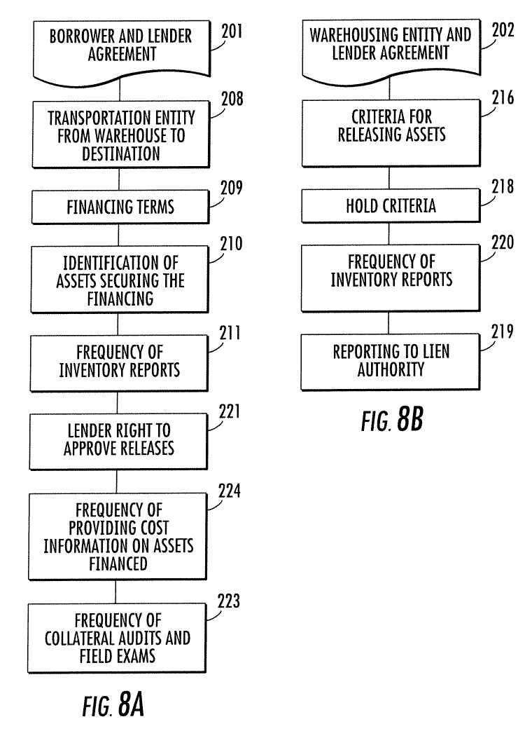

The financing process 100 begins at step 101 by the borrower soliciting the lender to finance warehoused inventory owned by the borrower. Following step 101, the lender and borrower agree on the financing terms to establish the borrowing base at step 102. The lender and the warehousing entity also enter into an agreement regarding how the inventory will be managed within the warehouse, shown as step 103. Exemplary terms included in the agreement between the lender and the borrower and the lender and the warehousing entity are discussed below in reference to FIGS. 8A and 8B, respectively. After the lender enters into agreements with the borrower and the warehousing entity, the warehousing entity provides an inventory report listing the inventory within the warehouse to the lender and the borrower, shown as step 104. The lender can use the inventory report to process various requests from the borrower and to exercise control over the assets within the warehouse. For example, in step 105, the lender uses the inventory report to process a request from the borrower to advance funds to the borrower under the terms of the financing agreement, and in step 106, the lender uses the inventory report to process a request from the borrower to release assets for shipment. Both of these steps are discussed below in more detail in relation to FIGS. 6 and 7, respectively. In addition, shown as step 107, the lender may use the inventory report to audit the inventory, such as to evaluate the reported cost price per asset to the current market cost price per asset, or audit the warehousing entity's warehousing procedures. Finally, in step 108, the lender can use the inventory report to foreclose upon the assets within the warehouse in the event of default or bankruptcy by the borrower. It should be noted that receipt of assets by the warehousing entity can occur before, after, or simultaneously with the lender entering into financing agreements with the borrower or the lender entering into warehousing agreements with the warehousing entity.

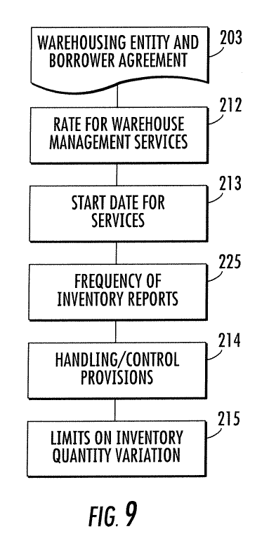

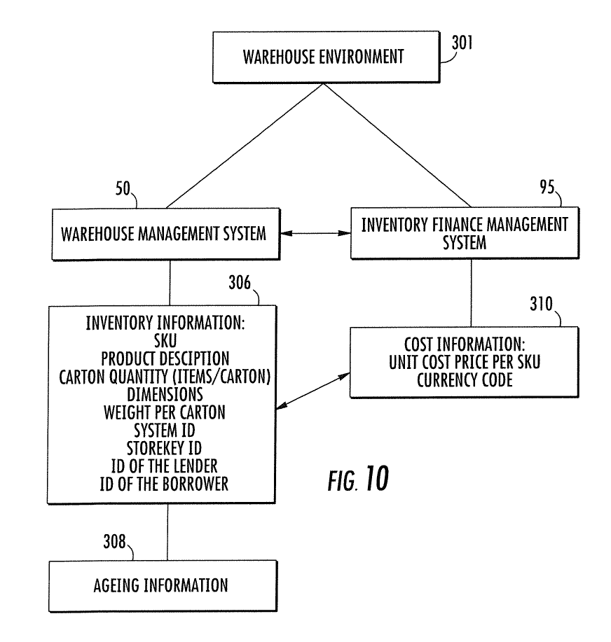

The warehousing process 130 of the system begins at step 131 by the borrower soliciting the warehousing entity to warehouse inventory owned by the borrower. Following step 131, the warehousing entity enters into an agreement with the borrower setting forth the responsibilities of each party regarding the inventory securing the financing and the business rules or criteria for governing aspects of the warehousing processes, shown as step 110. Exemplary terms of this agreement are described below in relation to FIG. 9. And, in step 103, as discussed above, the warehousing entity enters into an agreement with the lender. After the agreements are in place, the warehouse environment is set up, shown as step 112. Setting up the warehouse environment includes populating the warehouse management system 50 and the inventory finance management system 95 with at least a portion of the information used by each system in performing their respective functions, which is discussed in more detail below in relation to FIG. 10, and setting up the business rules that govern aspects of the warehousing processes.

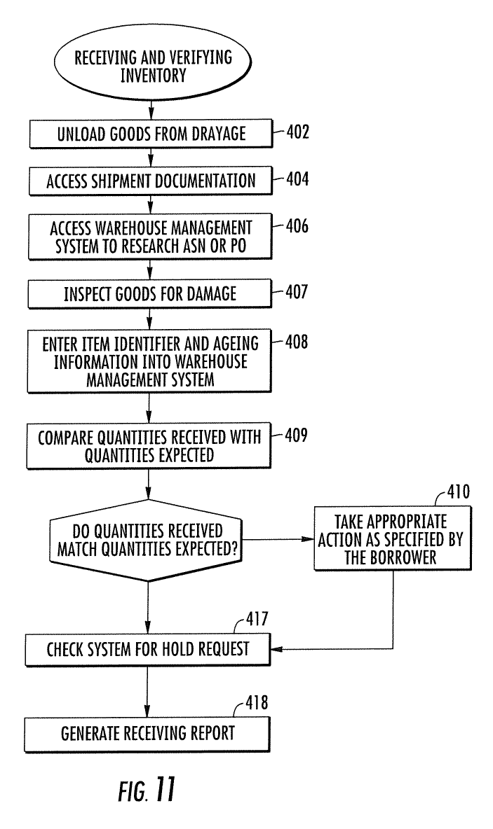

Next, in step 114, the warehousing entity receives a shipment of inventory and inspects the shipment and the shipping documentation to verify that the shipment is complete. Although described as occurring after step 131, step 112 of setting Up the warehouse environment and step 114 of receiving the inventory into the warehouse can occur before, after, or simultaneously with the borrower and the warehousing entity entering into a warehousing agreement or the borrower and lender entering into a financing agreement. After the inventory is received and inspected, a receiving report is generated and transmitted to the borrower and the lender identifying the collateral received by the warehouse, shown as step 122. Once the assets are received by the warehouse, any liens on the assets can be perfected and the lender can advance funds to the borrower. The process of receiving and verifying inventory is discussed in more detail below in relation to FIG. 11.

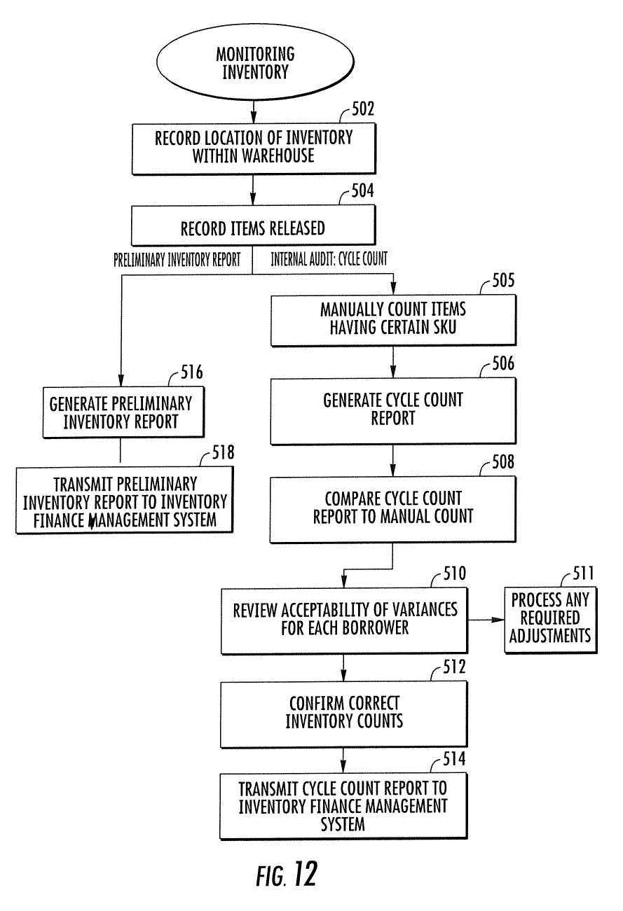

The warehousing entity continues to monitor inventory, as shown in step 116. For example, monitoring inventory includes recording assets that are present within the warehouse, updating the warehouse management system when the assets are released or when the location of an asset changes within the warehouse, and comparing cycle and physical count reports to manual counts. The step of monitoring inventory is discussed in more detail below in relation to FIG. 12.

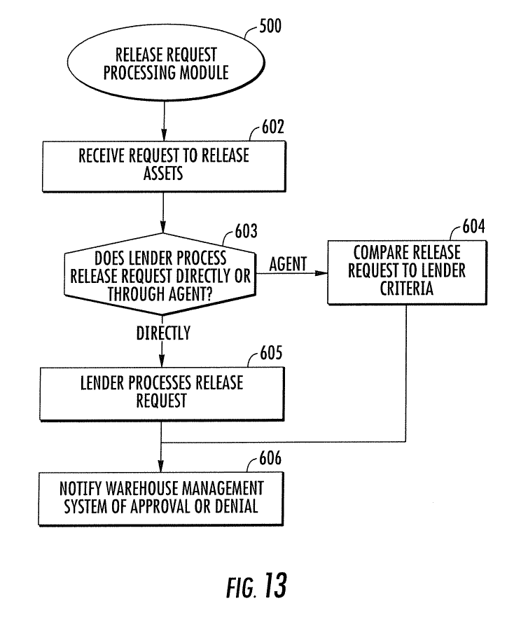

Eventually, the borrower will want at least a portion of the inventory assets subject to the security interest to be released by the warehousing entity. To initiate the release process, the borrower submits a release request identifying which assets the borrower wants released and the destination for these assets. Then, the lender evaluates the release request in light of current inventory levels, or the borrowing base, and the amount of outstanding credit extended previously to the borrower. The lender transmits its approval for the release request to the warehousing entity, shown as step 118, which allows the warehousing entity to release the assets identified in the release request for shipment. Exemplary steps for processing a release request are discussed in more detail below in relation to FIGS. 7 and 13.

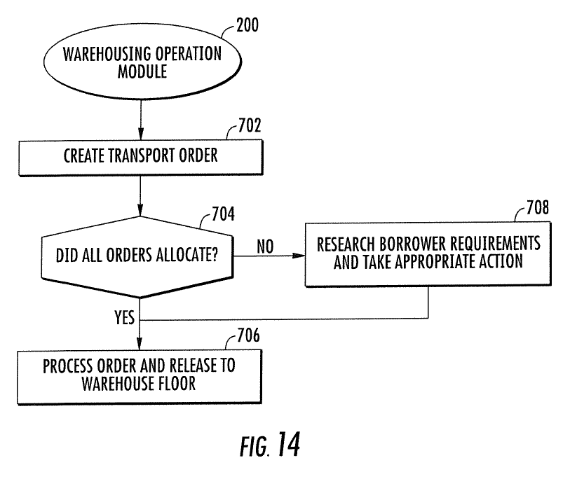

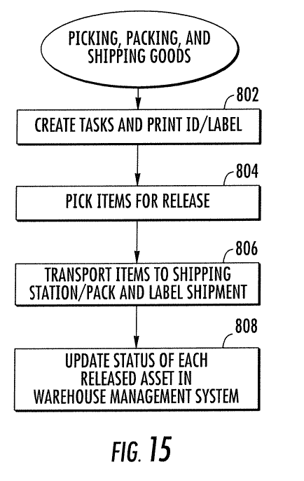

In step 120, if the release request is approved, the assets requested to be released are picked, packed, and shipped to the requested destination, which is discussed below in more detail in relation to FIGS. 14 and 15. Steps 114 to 120 are typically governed by an agreement between the warehousing entity and the borrower that sets forth the obligations of each party, such as document 203 described in relation to FIG. 9. After releasing the assets, the warehouse management system updates the inventory levels to reflect the release and reports the inventory levels to the inventory finance management system for generating an inventory report for the borrower, the lender, and any local lien authorities that require inventory reports, which is shown as step 122.

As mentioned in relation to step 105 of FIG. 5, FIG. 6 illustrates an exemplary flow diagram of how the lender or its agent processes a request from the borrower to advance funds under the financing agreement. At step 141, the lender receives a request to advance a certain amount of funds to the borrower. The lender then evaluates the amount of inventory listed in the borrowing base with the amount of inventory reported as present within the warehouse in the inventory report and any outstanding loan amounts, shown as step 143. In step 145, the advance request is approved and the funds are transferred to the borrower if a margin value of the assets, which is defined as the advance rate multiplied by the value of the assets present within the warehouse or expected to be received by the warehouse per the borrowing base, is greater than the outstanding loan amount. Otherwise, the advance request is denied. If the approval depends at least in part upon assets expected to be received into the warehouse, the lender may hold the funds until those assets are received and inspected. This embodiment describes the lender or its agent as processing the request from the borrower to advance funds. However, in an alternative embodiment, the warehouse management system 50 has the ability to evaluate the advance request on behalf of the lender using criteria specified in advance by the lender.

As mentioned in relation to step 106 of FIG. 5, an exemplary process of evaluating a request to release assets is shown in FIG. 7. In step 151, the lender receives a request to release a certain amount of assets. In response to this request, in step 153, the lender compares the margin value of the assets that would be left in the warehouse if the release was granted to the outstanding loan amount, including assets expected to be received by the warehouse per the borrowing base. In step 155, the release request is approved if the margin value of the assets that will be present within the warehouse per the borrowing base after the release occurs is greater than the outstanding loan amount. Otherwise, the request for release will be denied. If the approval depends at least in part upon assets expected to be received into the warehouse, the lender may hold the assets to be released until the expected assets are received and inspected. This embodiment describes the lender or its agent as processing the request from the borrower to release assets. However, in an alternative embodiment, the warehouse management system 50 has the ability to evaluate the release request on behalf of the lender using criteria specified in advance by the lender if allowed by the laws of the jurisdiction where the warehouse is located.

Referring back to steps 102, 103, and 110, the borrower, the lender, and the warehousing entity enter into agreements that set forth the obligations of each party with respect to the financing arrangement and the management of the inventory subject to the financing arrangement. FIGS. 8A, 8B, and 9 illustrate exemplary terms in the agreements between the borrower and the lender, the warehousing entity and the lender, and the warehousing entity and the borrower, respectively. In particular, document 201 shown in FIG. 8A represents the agreement between the borrower and the lender and includes the transportation entity or entities 208 authorized to transport the inventory to and from the warehouse and to the final destination, the financing terms 209, including the advance rate, the interest rate, and the borrowing base, the identification of the assets that secure the financing 210, the frequency 211 with which the borrower must provide the lender or the warehousing entity with asset reports listing the assets that the warehousing entity should have in its possession, the lenders right to approve releases 221, the frequency of collateral audits and field exams 223, and the frequency with which the borrower must provide cost information on the collateral to the lender 224.

Document 202 shown in FIG. 8B represents the agreement between the warehousing entity and the lender and includes criteria for releasing assets subject to security interests held by the lender 216, the frequency 220 with which the warehousing entity should provide the lender with inventory reports listing the assets within the warehouse subject to a security interest held by the lender, criteria for determining which assets should be held by the warehousing entity 218, and whether the warehousing entity is responsible for submitting inventory reports to the local lien authority 219.

Document 203 shown in FIG. 9 represents the agreement between the borrower and the warehousing entity setting forth the obligations of each party. Document 203 includes the rate 212 charged by the warehousing entity to the borrower for providing warehouse management services and the start date 213 for providing such services. In addition, document 203 sets forth the business rules governing warehousing operations, including the frequency 225 with which the warehousing entity should provide the borrower with inventory reports listing the assets within the warehouse belonging to the borrower, handling or control provisions 214 regarding the inventory, and limits on the inventory quantity variation acceptable to the lender 215. Although the above-described agreements are described as embodied in one of three documents 201, 202, and 203, the exemplary terms can be included in an oral agreement or in more than one document.

Once the parties have entered into the above agreements, the warehouse environment is set up. As illustrated in FIG. 10, the warehouse environment 301 includes a warehouse management system 50 and an inventory finance management system 95, which have been described above in relation to FIGS. 3 and 4. The inventory data collection module 100 of the warehouse management system 50 is configured to receive and store information 306 for each asset passing through the warehouse, including a stock keeping unit (SKU) number, product description, carton quantity, dimensions, weight per carton or weight per item, system identification number, storekey identification number, the identification of the lender having a security interest in the asset, and the identification of the borrower that owns the asset. In addition, the inventory data collection module 100 is configured to store ageing information 308 for each asset, such as the date the asset was manufactured or the date or the month and year it entered the warehouse.

The asset cost association module 400 of the inventory finance management system 95 is configured to receive asset information 306 from the warehouse management system 50 and associate cost information 310 with each asset. For example, cost information 310 includes the cost price per SKU and a currency code indicating the currency of the cost price. In one embodiment, the cost information 310 can be provided by the borrower or by the lender, and the lender may require the borrower to update the cost information 310 periodically such as once a week, a month, or a quarter.

After the warehousing environment 301 is set up, the warehousing entity is in a position to receive and verify receipt of inventory subject to security interests, as shown in FIG. 11. First, the assets subject to the security interest are unloaded from drayage, shown as step 402. Next, the warehousing entity accesses the shipment documentation accompanying the assets, shown as step 404. Shipment documentation includes advance shipping notices (ASN) and purchase orders (PO), for example. If the shipment documentation can be provided electronically to the warehouse management system 50 such as via email or an Excel file, the data is received electronically by warehouse management system 50. However, if the shipping documentation is not available electronically, the data in the documentation can be entered into the warehouse management system 50 manually. Once the shipping documentation is entered into the system 50, the inventory data collection module 100 stores the documentation in a memory on the system 50. As shown in step 406, the warehouse management system 50 uses the data from the shipment documentation to determine the identity of the borrower and the lender and the identification of the goods that should be included in the shipment.

After receiving the shipping documentation and determining the identification of the borrower, the lender, and the assets listed as included in the shipment, the warehousing entity inspects the assets for damage, shown in step 407. Next, identifying) information, such as SKU numbers, and ageing information for each undamaged asset actually received by the warehousing entity are entered into the warehouse management system 50, shown as step 408. Methods for entering identifying information into the warehouse management system 50 include, for example, scanning bar codes or other optical indicia, RFID tags positioned on each asset, or Bluetooth™ devices, or manually entering the SKU number of some other item-level identifier into the warehouse management system 50.

Then, in step 409, the quantity verification module 600 of the warehouse management system 50 compares the assets listed in the shipment documentation with the undamaged assets actually received. If the difference in quantity received and quantity expected is outside the acceptable variation limits for the borrower, the quantity verification module 600 determines the appropriate action that has been specified by the borrower, shown as step 410. For example, if the quantity received exceeds the quantity expected above a certain amount specified in advance by the borrower, an overage validation is performed. The quantity variation module 600 can perform the overage validation by comparing the difference in the quantity received and the quantity expected to an acceptable overage limit set by the borrower in advance. If the overage is within the limits set by the borrower, the shipment can be accepted, and if the overage is outside the borrowers limits, the shipment should be rejected. However, if the quantity received is less than the quantity expected below a certain acceptable amount, the warehousing management system researches the appropriate action specified in advance by the borrower for how to handle quantities received that are less than the expected quantity. Appropriate actions include, for example, notifying the borrower, rejecting the shipment, and putting a hold on the shipment.

After assets have been accepted and identifying information for each asset has been entered into the warehouse management system 50, the warehousing management system 50 is checked for any special requests for handling the assets, such as putting one or more of them on hold, shown in step 417, and the assets become “loanable,” meaning that they are eligible to serve as collateral for funds advanced under the financing arrangement. Then, the inventory reporting module 300 of the warehousing management system 50 generates a type of inventory report referred to as a receiving report, as shown in step 418. The receiving report is transmitted or made available to the borrower and lender. For example, the receiving report can be emailed, faxed, or mailed to the borrower and lender or it can be posted to a network system and viewed by the borrower and lender.

While the goods are stored at the warehouse, the warehouse management system 50 and warehouse personnel monitor the inventory. FIG. 12 illustrates a method of monitoring inventory. Beginning at step 502, the inventory data collection module 100 of the warehouse management system 50 records the location of each asset within the warehouse, including its initial location and any later locations within the warehouse. Recording the location of each asset provides improved efficiencies in picking and packing operations and demonstrates control over the assets by the warehousing entity on behalf of the lender. In addition, when assets are later released by the warehouse, the identities of the released assets are recorded in the warehouse management system 50 by the inventory data collection module 100, shown as step 504, which allows the warehouse management system 50 or the inventory finance management system 95 to report the release to the lender, borrower, and lien authority.

Although the performance of internal audits of warehouse procedures and inventory is not necessarily a prerequisite to the financing process, the agreements between the warehousing entity and the borrower may require the warehousing entity to perform internal audits, such as by performing periodic cycle counts and physical inventory counts. The internal audits identify problems with warehouse management procedures and any inventory shrinkage issues that need to be addressed. In a cycle count, the warehousing entity manually counts certain items, such as those items having a particular SKU, within the warehouse and compares the manual count amount to the amount shown in the warehouse management system 50. In a physical inventory count, the warehousing entity manually counts all items within the warehouse and compares the manual count amount to the amount shown in the warehouse management system 50. Internal audits are typically performed on a monthly, quarterly, or yearly basis, and can be set as a function of the velocity of assets moving through the warehouse. In addition, to protect the lender's interest in the assets, a field examiner acting on behalf of the lender may examine the audit procedures of the warehousing entity, and if the field examiner does not approve of the audit procedures, the field examiner may suggest changes in the procedures to the borrower or conduct an independent audit.

Steps 505 to 514 illustrate how an exemplary cycle count is conducted. First, in step 505, the warehousing entity manually counts the items within the warehouse having a certain SKU and enters the manual count amount into the warehouse management system 50, and, at step 506, the inventory reporting module 300 generates a cycle count report that includes the number of items having the certain SKU that the warehouse management system 50 shows as present within the warehouse. Then, at step 508, the quantity variation module 600 compares the manual count amount to the cycle count report amount. If there is a variance between the amount of inventory reported in the cycle count report and the amount of inventory manually counted, the quantity variation module 600 reviews the acceptable ranges for variances as specified by the borrower, as shown in step 510. If the variation is within the acceptable range, the manual count amount is added into the cycle count report by the inventory reporting module 300, shown as step 512, and the cycle count report is transmitted to the inventory finance management system 95, shown as step 514. If, however, the variance is outside of the acceptable range, the warehousing entity processes adjustments to the cycle count report according to criteria set forth in the agreement between the warehousing entity and the borrower, shown in step 511. For example, the criteria may require that the warehousing entity notify the borrower or the lender when the variance is outside the acceptable range, or the criteria may require that the warehousing entity conduct a second manual count or pay a portion of the value of the assets that are unavailable.

In addition to performing internal audits such as cycle and physical counts, the warehousing entity may also be responsible for reporting up-to-date inventory information to the borrower, the lender, and the local lien authority, where required, on a predetermined time basis, such as once per day or once every few days. The predetermined time interval in one embodiment is a function of the time required by the lender to process a request to advance funds. As shown in FIG. 12, at step 516, the inventory reporting module 300 generates a preliminary inventory report that includes the data for the inventory within the warehouse at the end of the predetermined time interval. Then, at step 518, the warehouse management system 50 transmits the inventory data to the inventory finance management system 95.

As described above in relation to FIG. 7, when a borrower wants an asset or group of assets that are subject to a lien to be released from the warehouse, the borrower submits a request to release the assets. The release request can be submitted directly to a lender or a collateral agent, or the release request can be submitted to the warehousing entity depending on the control requirements of the jurisdiction. If the release request is submitted to the warehousing entity, the release request processing module 500 of the inventory finance management system 95 receives and processes the release request by executing the steps shown in FIG. 13. In step 602, the release request processing module 500 receives a request to release the assets. Then, in step 603, the release request processing module 500 determines whether the lender is required to process the release request directly or whether the warehousing entity can process the request on behalf of the lender and according to the lender's criteria. If the lender must process the request directly, the release request is forwarded to the lender and the lender processes the request, shown as step 605. The release request may be forwarded to the lender via email, by posting the release request to an automatic or network messaging board, facsimile, or mail, for example. If the warehousing entity can process the request on behalf of the lender, the release request processing module 500 compares the release request received to the lender criteria for release requests, as shown in step 604. According to one embodiment, the release request criteria set by the lender requires the release request to include the identification of the assets requested for release, the shipment destination, and the cost price per asset.

In one embodiment, the lender automatically processes the release request using the lender's computer system, and in another embodiment, the release request is manually evaluated. The lender then informs the inventory finance management system 95 whether the release request is approved or denied. And, in step 606, the warehouse management system 50 is notified whether the assets can be released.

In one embodiment, upon receiving the notification from the inventory finance management system 95 that the lender approves of the release, the borrower provides shipping documentation to the lender for the assets to be released. Examples of shipping documentation include a trust receipt, a forwarder's cargo receipt (FCR), or a bill of lading. The release is then processed by the warehousing operation module 200 of the warehouse management system 50. As shown in , FIG. 14, the warehousing operation module 200 creates a transport order in step 702, which includes instructions to the warehousing entity to pick, pack, and ship the assets. Then, in step 704, the warehousing operation module 200 determines whether all of the assets in the transport order are available based on the inventory recorded in the warehouse management system 50. If all of the assets are available, then the transport order is processed and the assets are released to the warehouse floor for further processing by the warehouse management system 50, as shown in step 706. However, if the order includes assets that are unavailable, the warehousing operation module 200 researches guidelines set by the borrower regarding the appropriate action to take, shown as step 708. Appropriate actions may include holding the available assets for shipment until the unavailable assets become available, canceling the release of the assets until all assets become available, or shipping the portion of the assets that are currently available and shipping those assets that are currently unavailable at a later time.

After the assets are released to the warehouse floor, the assets are ready to be picked, packed, and shipped to the indicated destination. As shown in FIG. 15, tasks are created and ID labels are printed in step 802. Task can include instructions to pick particular assets in a particular order based on the location of the assets within the warehouse, for example, and ID labels identify the shipping instructions for each asset. Then, in step 804, assets are picked for release by warehousing personnel or an automated warehousing system, such as known automated warehousing systems. The assets are then transported to a shipping station within the warehouse where the assets are packed and labeled for shipment to the destination, as shown in step 806. In step 808, the inventory data collection module 100 of the warehouse management system 50 updates the status of each asset after preparing the assets for shipment. The status of each asset may include an indication that the asset is located within the shipping station, the asset is ready for shipment, or the asset has been shipped.

As described above, assets stored within a warehouse may serve as collateral for a financing arrangement within a financing agreement. In a further embodiment, the financing agreement may include additional financing arrangements in which the assets may serve as collateral while they are in transit to or from the warehouse. For example, while the assets are stored within the warehouse, they are considered to be in a “warehouse lending bucket,” meaning the assets are eligible to serve as collateral for a financing arrangement having a first set of terms. After the assets are marked as ready for shipment or are in transit from the warehouse, they are considered to be in an “in-transit lending bucket,” meaning the assets are eligible to serve as collateral for a financing arrangement having a second set of terms. The terms of each financing arrangement may vary depending on the amount of risk perceived by the lender.

Because the inventory data collection module 100 of the warehouse management system 50 updates the warehouse management system 50 when any change in status occurs with an asset, the data in the system 50 is kept up-to-date. Keeping the data up-to-date facilitates the reporting responsibilities imposed on the warehousing entity and provides enhanced visibility of the inventory for the borrower and the lender. In addition, the inventory can be updated on at least a daily basis which allows the warehousing entity to report to the lender, the borrower, and the lien authority an up-to-date listing of the inventory present in the warehouse at a particular cut-off time on a daily basis if required.

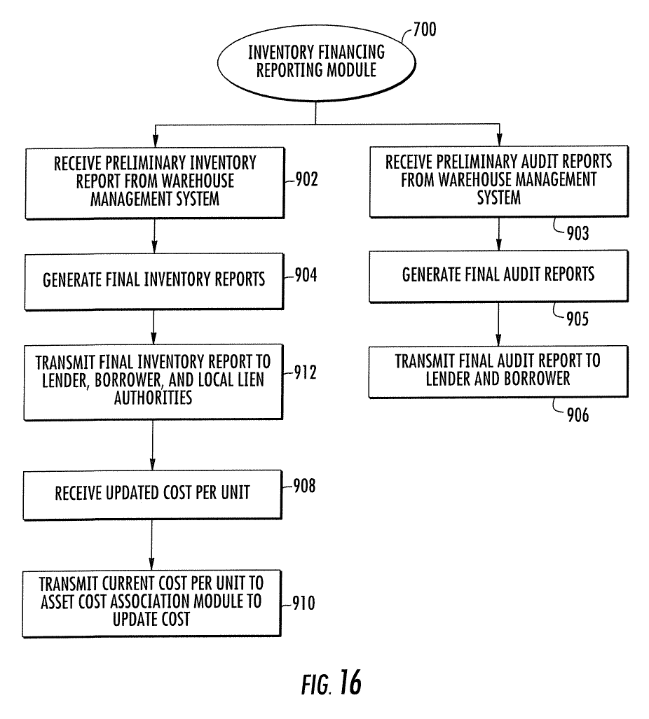

FIG. 16 illustrates how the inventory finance report module 700 of the inventory finance management system 95 operates to provide audit reports, such as cycle count and physical count reports, and up-to-date inventory reports to borrowers, lenders, and local lien authorities. As discussed above in relation to FIG. 12, audit reports serve as auditing tools to ensure that the warehousing entity is properly controlling the goods stored within the warehouse. Inventory reports serve as a reporting tool to inform the borrower, lender, and local lien authority, where required, of the inventory available in the warehouse as of the end of the predetermined time interval, or cut-off time. The process of generating an inventory report begins at step 902 with the inventory finance report module 700 receiving a report from the warehouse management system 50, such as the up-to-date preliminary inventory report transmitted from the warehouse management system 50 in step 518 of FIG. 12. Then, in step 904, the inventory finance report module 700 generates a final inventory report using the preliminary inventory report transmitted from the warehouse management system 50. The final report may include certain formatting requirements of the receiving party and may be tailored to include information relating only to the receiving party. For example, the preliminary inventory report may include all items within the warehouse as of the predetermined cut off time, but one of the reports for a particular lender generated by the inventory finance reporting module 700 includes only information on the assets subject to a security interest held by the particular lender. In addition, the inventory report may include the cost per unit for each item included in the report as of the time the report was generated. Next, in step 912, the inventory finance report module 700 transmits or otherwise makes available the final inventory report to the interested parties, such as the lender, the borrower, and the local lien authority, where required, using email, instant messaging, by posting the report to an automatic or network messaging board, facsimile, mail, or phone, for example.

Upon receipt of the final inventory report, the lender audits the cost prices to ensure that the cost prices reflected in the inventory report rejects the current cost prices for the assets based on the market. If there is a discrepancy in the cost prices, the lender notifies the inventory financing reporting module 700 of the discrepancy, shown as step 908, and the inventory finance report module 700 sends the updated cost price information to the asset cost association module 400, which then updates the cost price to the current cost price per unit, shown as step 910. In another embodiment, the borrower may notify the inventory finance management system 95 of a discrepancy in the reported cost price in the inventory report and the current cost price. In an alternative embodiment, the inventory financing reporting module 700 may operate on the warehouse management system 50 and serve the function of the inventory reporting module 300 of the warehouse management system 50, thus making the generation of preliminary inventory and audit reports unnecessary.

Similarly, the process of generating a final audit report begins at step 903 with the inventory finance report module 700 receiving a preliminary audit report from the warehouse management system 50, such as the cycle count report transmitted in step 514 of FIG. 12. Then, in step 905, the inventory finance report module 700 generates a final audit report using the preliminary audit report transmitted from the warehouse management system 50. Next, in step 906, the inventory finance report module 700 transmits or otherwise makes available the final audit report to the interested parties, such as the borrower and the lender.

Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

1. An asset management system for managing one or more assets pledged as collateral for one or more loans and stored within a warehouse, said system comprising:
an inventory data collection module adapted for receiving and storing into a memory asset information for an asset received into said warehouse, said asset information for said asset comprising an asset identifier for identifying said asset, a lender identifier for identifying a lender having a lien against said asset, a borrower identifier for identifying a borrower that owns said asset, and a location identifier for identifying a location of said asset within said warehouse; and
an inventory financing reporting module adapted for:
generating an inventory report for said borrower and said lender, said inventory report comprising at least a portion of said asset information for said asset; and
in response to generating said inventory report, transmitting said inventory report to said borrower.

2. The asset management system of claim 1 wherein said inventory financing reporting module is further adapted for transmitting said inventory report to a local lien authority.

3. The asset management system of claim 1 wherein said inventory financing reporting module is further adapted for transmitting said inventory report to said lender.

4. The asset management system of claim 1 wherein said inventory financing reporting module is further adapted for transmitting said inventory report to a collateral agent associated with said lender.

5. The asset management system of claim 1 wherein:
said inventory data collection module is adapted for receiving and storing into a memory asset information for a plurality of said assets; and
said asset information stored in said memory comprises a first set of asset information associated with asset identifiers identifying a first set of said assets and a second set of asset information associated with asset identifiers identifying a second set of said assets, said first set of assets being owned by a first borrower and securing a first lien held by a first lender, and said second set of assets being owned by a second borrower and securing a second lien held by a second lender.

6. The asset management system of claim 5 wherein said inventory financing reporting module is further adapted for generating a first inventory report for said first borrower and said first lender and a second inventory report for said second borrower and said second lender, said first inventory report comprising at least a portion of said asset information for said first group of assets and said second inventory report comprising at least a portion of said asset information for said second group of assets.

7. The asset management system of claim 1 further comprising a cost association module adapted for receiving cost information for said asset and associating said cost information with said asset identifier in said memory.

8. The asset management system of claim 7 wherein said inventory report further comprises said cost information.

9. The asset management system of claim 1 further comprising a release request processing module adapted for:
receiving a release request from said borrower to release said asset owned by said borrower from said warehouse; and
in response to receiving said request, retrieving release criteria associated with said lender and comparing said release request to said release criteria, said release criteria being stored in said memory.

10. The asset management system of claim 9 wherein said release request processing module is further adapted for generating instructions to release said asset in response to said release request at least substantially meeting said release criteria and transmitting said instructions to said warehouse.

11. The asset management system of claim 1 further comprising a warehousing operation module for processing instructions to release said asset from said warehouse, said warehousing operation module adapted for executing the steps of:
receiving instructions to release said asset owned by said borrower, said instructions identifying said asset to be released;
in response to receiving said instructions, creating a transport order, said transport order comprising instructions to pick, pack, and ship said asset;
determining whether said asset in said transport order is available for picking, packing, and shipping;
in response to determining that said asset in said transport order are available, releasing said asset in said transport order to a warehouse floor for picking, packing, and shipping; and
in response to determining that said asset in said transport order is available, retrieving guidelines established by said borrower regarding an action to take with respect to said asset in said transport order.

12. The asset management system of claim 11 wherein said transport order comprises instructions to pick, pack, and ship a plurality of said assets, and wherein said action is selected from the group comprised of: (1) holding one or more available assets for shipment until one or more unavailable assets become available, (2) canceling said transport order for said assets in said transport order until all of said assets in said transport order become available, or (3) shipping one or more available assets and shipping one or more unavailable assets at a later time.

13. The asset management system of claim 12 wherein said step of determining whether said assets in said transport order are available for picking, packing, and shipping comprises comparing said asset identifiers associated with each of said assets in said transport order to said asset identifiers stored in said memory.

14. The asset management system of claim 11 wherein said instructions to release said asset are received from said lender associated with said asset.

15. The asset management system of claim 11 wherein said instructions to release said asset are received from a release request processing module.

16. The asset management system of claim 11 wherein said inventory data collection module is further adapted for updating a status of said asset in said transport order in response to releasing said asset to said warehouse floor for picking, packing, and shipping.

17. The asset management system of claim 16 wherein said status is selected from the group comprised of: an indication that said asset is located within a shipping station, an indication that said asset is ready for shipment, or an indication that said asset has been shipped.

18. The asset management system of claim 1 wherein said asset identifier is a stock keeping unit number.

19. The asset management system of claim 1 wherein said asset identifier identifies each asset on a carton-level basis.

20. The asset management system of claim 1 wherein said inventory data collection module is adapted for receiving and storing into a memory asset information for a plurality of said assets; and
further comprising a quantity validation module adapted for:
determining whether asset identifiers associated with said assets received into said warehouse are different from said asset identifiers associated with said assets expected to be received into said warehouse, said received assets and said expected assets being associated with said lender;
in response to determining that said received assets are different than said expected assets, retrieving quantity variation criteria associated with said lender, said quantity variation criteria being stored in said memory; and
in response to retrieving said quantity variation criteria, comparing said received assets and said expected assets to said quantity variation criteria.

21. The asset management system of claim 20 wherein said quantity variation criteria comprises a pre-established range of acceptable differences between said received assets and said expected assets, and wherein said quantity validation module is further adapted for notifying said lender of a difference in quantity between said received assets and said expected assets in response to said difference in quantity being outside of said pre-established acceptable range.

22. The asset management system of claim 20 wherein said received assets comprise undamaged assets.

23. The asset management system of claim 20 wherein asset identifiers for said expected assets are provided in shipping documentation associated with said received assets.

24. The asset management system of claim 23 wherein said shipping documentation is provided to said warehouse electronically.

25. The asset management system of claim 1 wherein said inventory data collection module is further adapted for monitoring a location of said asset within said warehouse, said monitoring comprises updating said location identifier associated with said asset in said memory in response to said asset being physically moved within said warehouse.

26. The asset management system of claim 1 wherein said inventory financing reporting module is further adapted for receiving from said borrower updated cost information associated with said asset included in said inventory report and transmitting said updated cost information to a cost association module.

27. The asset management system of claim 1 further comprising a release request processing module adapted for:
receiving an approval from said lender to release said asset from said warehouse, said asset being identified in a release request submitted to said lender by said borrower, said borrower owning said asset and said lender having a lien against said asset; and
in response to receiving said approval, generating instructions to release said asset.

28. A computer system for facilitating the exercise of control over an asset stored within a warehouse, said asset being owned by a borrower and designated as collateral for a loan provided to said borrower by a lender, said system comprising:
an asset manager adapted for (1) storing an asset identifier for said asset located within said warehouse, said asset identifier identifying said asset, and (2) associating and storing a lender identifier associated with said asset, said lender identifier identifying said lender as having a lien against said asset;
a release manager adapted for storing release criteria associated with said lender and, in response to receiving a release request from said borrower to release said asset associated with said lender, comparing said release request to said release criteria associated with said lender; and
a report generator adapted for generating a report of said asset within said warehouse at a given time and transmitting said report to a lien authority.

29. The computer system of claim 28 wherein said asset identifier is collected by electronically scanning said asset.

30. The computer system of claim 29 wherein a type of said electronic scanning is selectable from the group consisting of: RFID, optical indicia, bar coding, and Bluetooth™.

31. An inventory management system for managing one or more warehoused assets securing a loan, said system comprising:
a memory adapted for storing release criteria associated with a lender and an inventory report provided by a warehousing entity storing said warehoused assets, said inventory report comprising asset information for each of said warehoused assets;
a processor adapted for executing the steps of:
receiving a release request from a borrower, said release request identifying at least one of said warehoused assets owned by said borrower;
in response to receiving said release request, comparing said release request to said release criteria; and
in response to determining that said release request meets said release criteria, approving said release request and generating instructions for said at least one of said warehoused assets to be released from said warehouse.

32. The inventory management system of claim 31 wherein said processor is further adapted for receiving updated release criteria associated with said lender and said memory is further adapted for storing said updated release criteria.

33. The inventory management system of claim 31 wherein said memory and said processor reside on a computer system associated with said warehousing entity.

34. The inventory management system of claim 31 wherein said memory and said processor reside on a computer system associated with said lender.

35. The inventory management system of claim 34 wherein:
said memory is further adapted for storing a borrowing base received from said borrower; and
said step of comparing said release request to said release criteria comprises comparing said release request with said inventory report and said borrowing base.

36. The inventory management system of claim 35 wherein said processor is further adapted for receiving an updated borrowing base from said borrower and said memory is further adapted for storing said updated borrowing base.

37. The inventory management system of claim 35 wherein said step of comparing said release request with said inventory report and said borrowing base further comprises comparing a value of assets listed in said inventory report, a value of assets listed in said borrowing base, and any outstanding loan amounts provided by said lender to said borrower with a value of said at least one of said warehoused assets identified in said release request.

38. The inventory management system of claim 37 wherein said processor is further adapted for:
approving said release request in response to said value of assets listed in said inventory report and said value of assets listed as being within said warehouse in said borrowing base being greater than or equal to a sum of said value of said at least one of said warehoused assets identified in said release request and said outstanding loan amounts; and
denying said release request in response to said value of assets listed in said inventory report and said value of assets listed in said borrowing base being less than said sum.

39. The inventory management system of claim 34, said processor further adapted for executing the steps of:
receiving an advance funds request from said borrower, said advance funds request comprising an amount of funds requested to be released by said lender to said borrower;
in response to receiving said advance funds request, comparing said advance funds request with funds release criteria stored in said memory, said step of comparing said advance funds request with said funds release criteria comprises the steps of comparing said inventory report, said borrowing base, and any outstanding loan amounts with said amount in said advance funds request; and
in response to determining that at least a portion of said funds in said funds release request can be released according to said funds release criteria, approving said advance funds request and generating instructions for said funds to be paid to said borrower.

40. The inventory management system of claim 39 wherein said step of comparing said advance funds request with said inventory report, said borrowing base, and said outstanding loan amounts further comprises comparing a value of assets listed in said inventory report, a value of assets listed in said borrowing base, and any outstanding loan amounts provided by said lender to said borrower with said amount in said advance funds request.

41. The inventory management system of claim 40 wherein said processor is further adapted for:
approving said advance funds request in response to said value of assets listed in said inventory report and said value of assets listed as being within said warehouse in said borrowing base being greater than or equal to a sum of said amount in said advance funds request and said outstanding loan amounts; and
denying said advance funds request in response to at least one of said value of assets listed in said inventory report and said value of assets listed in said borrowing base being less than said sum.

42. A method of facilitating perfection of a lien against one or more assets within a warehouse, said method comprising the steps of:
receiving said one or more assets subject to said lien into said warehouse;
storing an asset identifier for each of said one or more assets in a memory, said asset identifier identifying said asset;
associating a lender identifier with each of said asset identifiers, said lender identifier identifying said lender holding said lien;
associating location identifier with each of said asset identifiers, said location identifier identifying a physical location of said asset within said warehouse; and
generating an inventory report comprising said asset identifier, said lender identifier, and said location identifier for each of said one more assets within said warehouse at a given time.

43. The method of claim 42 wherein said given time is approximately a time at which said inventory report is generated.

44. The method of claim 42 further comprising the step of transmitting said inventory report to a local lien authority.

45. The method of claim 42 further comprising the step of transmitting said inventory report to said lender.

46. The method of claim 42 further comprising the step of transmitting said inventory report to a collateral agent associated with said lender.
